(19) United States
(12) Patent Application Publication
(10) Pub. No.: US 2021/0371128 A1
(43) Pub. Date: Dec. 2, 2021

(54) Drone Landing Pad System for Receiving Parcels & Packages

(71) Applicants: Luis Rodriguez, Whittier, CA (US); Kathleen Rodriguez, Whittier, CA (US)

(72) Inventors: Luis Rodriguez, Whittier, CA (US); Kathleen Rodriguez, Whittier, CA (US)

(21) Appl. No.: 17/331,372

(22) Filed: May 26, 2021

Related U.S. Application Data
(60) Provisional application No. 63/030,681, filed on May 27, 2020.

(51) Int. Cl. B64F 1/32; B64F 1/20

(52) U.S. Cl. CPC B64F 1/322; B64C 39/024; B64F 1/20

(57) ABSTRACT

A Drone Landing Pad (DLP) allows landing a drone or delivering a parcel and includes an interior platform which lowers into the DLP or a cushioned interior platform, and an upper platform above the interior platform which opens to receive parcels and closes to protect parcels. The DLP may include two way communication with drones to provide a DLP position and receive drone position and ETA. The DLP position may be programmed into a DLP processor, or may be a GPS position when the DLP is movable to different locations. An optical landing aid may be provided to guide the drone to the DLP in a safe and reliable manner and confirm the DLP, for example an optical landing aid affixed or painted on the DLP. The DLP may be equipped with solar paneling for self-sustaining continuous charge or include battery backup and direct power options to ensure safe delivery.

### CROSS-REFERENCE TO RELATED APPLICATIONS

The present application claims the priority of U.S. Provisional Patent Application Ser. No. 63/030,681 filed May 27, 2020, which application is incorporated in its entirety herein by reference.

### BACKGROUND OF THE INVENTION

The present invention relates generally to a receptacle system for receiving and securing parcels and packages and in particular to a receptacle system for parcels delivered by a drone. The use of the receptacle system may rely on, and possibly contribute to, pending government regulations in the future operations of Unmanned Aerial Vehicles (UAV) or Unmanned Aerial Systems (UAS), both types of drones.

Drones have become a popular hobby. Unfortunately, public drone use has become a nuisance to public safety personnel because privately and publicly operated drones are frequently entering airspace that needs to be clear for public safety use or violates personal privacy. The use of commercial drones is becoming a new market for the delivery of goods and services. Unfortunately, unsecured packages are often stolen, and because a drone delivery is conspicuous, it is even more likely that a parcel delivered by a drone will be stolen.

Known drones typically are guided visually by the operator, due to “line of sight” rules. Landing a drone usually means the drone is guided to an open field or area, and onto solid hard ground. For the inexperienced operator, landing a drone can at times damage the drone against the hard ground.

### BRIEF SUMMARY OF THE INVENTION

The present invention addresses the above and other needs by providing a Drone Landing Pad (DLP) that allows safely delivering parcels/deliverables. The DLP includes an interior platform which lowers into the DLP, and a security door or top platform above the interior platform which opens to receive packages and closes to protect the packages. The drone may land on the DLP or release the parcel on or into the DLP without landing. The DLP may include two way communication with drones to provide a DLP position and receive drone position and ETA. The DLP position may be programmed into a DLP processor, or may be provided in real time by a GPS receiver when the DLP is movable to different locations. An optical landing aid may be provided to guide the drone to the DLP in a safe and reliable manner and confirm the DLP, for example an optical landing aid applied to the top of the DLP. The DLP may be equipped with solar paneling for self-sustaining continuous charge but will also be enhanced with battery backup and direct power options to ensure safe delivery. The DLP may also accept in-person deliveries. The DLP provides a tool to safely navigate to a certain location autonomously to deliver and secure a parcel/deliverable.

In accordance with one aspect of the invention, the DLP may include a fixed and bolted down steel frame or be movable and may include composite materials. The frame walls and base are enclosed with weatherproof composite materials to create the receptacle space. The size of the DLP may depend upon residential or commercial use or customer preference.

In accordance with one aspect of the invention, the DLP includes a platform which may be raised to the top of the frame to receive a parcel and lowered into a receptacle space for securing the package. The DLP is ready to automatically receive packages into the receptacle space, by positioning the platform level with the top of the receptacle space. The platform would be engaged by the delivery of the parcel placed on top of the platform by the drone, which will have signaled the DLP that it is within a certain range of having a parcel delivered. Upon placement of the parcel onto the platform, the platform will automatically lower by use of sensor(s) and/or receptors that will send a signal to a DLP processor to lower the platform and the parcel within the receptacle space by a lifting/lowering device. The lifting/lowering device may be operated by geared electrical motors and/or hydraulic piston to safely guide and lower the platform with a scissor lift and guide rails (electric geared motors vs. electrically activated hydraulic pistons would depend on size and model). The electric motor and/or hydraulic piston are controlled by signals from the DLP processor.

In accordance with another aspect of the invention, the DLP may include a security roll-up door automatically opened while expecting the next delivery, and closed once the parcel is within the receptacle space to secure from theft and exposure to weather. The door may be opened to receive additional packages when sensors determine that space is available, and the drone provides size information on the additional package.

In accordance with yet another aspect of the invention, the DLP may include a GPS sensor providing DLP location to the DLP processor, or DLP location may be programmed into the DLP processor. The DLP processor transmits the DLP location to the drone to guide the drone to the DLP for parcel delivery, where it hovers and centers over the DLP, may land on a platform, release, fly away leaving the parcel on the platform.

In accordance with still another aspect of the invention, the DLP may include an affixed optical scanning icon affixed/painted to a top surface of the DLP for easy recognition by the drone's optical recognition camera. Additional measures like the use of bollards or low fencing can be installed to protect the DPL from vehicles in or near parking areas. Next to the GPS sensor, or within the receptacle, a bar code reader may be optionally affixed to read the bar codes of the incoming delivery packages. A scale option may also be affixed to the drone pad to further verify and validate parcel as ordered.

In accordance with another aspect of the invention the DLP guides drones to a GPS designated coordinate to deliver commercial packages. The DLP has either a programmed location, or a GPS receiver to determine location. The DLP communicates with the drone to provide the DLP location to the drone.

In accordance with another aspect of the invention the DLP may include solar panels. The DLP may be hard-wired to a power source or may be equipped with rechargeable batteries that will be recharged by the solar panels when exposed to a light source. This feature is to consider continued operation during neighborhood power outages.

In accordance with yet another aspect of the invention the DLP may communicate with a GPS equipped drone. The DLP may include a GPS sensor to continuously establish a DLP position, or the DLP position may be determined once for a fixed DLP. The DLP may provide the DLP location to an en route drone, and the drone may estimate an arrival time and provide the time estimate to the DLP.

In accordance with yet another aspect of the invention, each DLP may have its location coordinates registered as part of a network of DLPs available for receiving packages, for example connecting DLP s together via the Internet. A drone may quarry the network of DLPs to determine a preferred DLP for a package.

In accordance with still another aspect of the invention an optical scanning icon may be applied to the top of the DLP for recognition by an optical scanning camera carried by the drone. The optical scanning icon includes a unique pattern to identify and verify location to deliver, land, and release or drop a parcel before flying to next delivery assignment.

In accordance with another aspect of the invention, business to business or business to residential delivery use is facilitated by using drones to deliver, for example, packages to the DLP, which eliminates the need for trucks for various distance deliveries, thereby reducing fuel consumption, gas emissions, reduce number of certain delivery fleet vehicles, and eliminate potential road accidents or hazards. This is very important in today's push for reduction of Green House Gas (GHG) emissions, auto related smog and pollution (fluid leaks & tire rubber on streets that wash into the ocean), and the world trying to slow down climate change in general. This device will substantially reduce the need for vehicular trips to obtain goods and services. In operation, a customer will place an order through a “smart” phone or web-based platform, and the order is automatically linked with the specific GPS sensor's ID code for that certain DLP. When ready, the sender may dial the customer's phone number, email, or GPS ID number to determine coordinates all linked to a computer and/or smartphone, and the drone's navigational system can guide the drone to the drone pad's GPS coordinates, and the help of an optical landing aid for precise location of the DLP.

In accordance with another aspect of the invention an additionally, contemporary technology may be included which allows control of the DLP motor. For example and ethernet optional, use an operating system for connectivity & serial communication or USB for GPS, and open source hardware & operating system such as that of the Raspberry Pi (operating system).

In accordance with still another aspect of the invention, there is provided a DLP including a platform that can receive a parcel/package atop the platform, whereupon the platform opens horizontally from the middle of the platform to allow the parcel to drop into the receptacle with the aid of parcel pushers that force the drop of the parcel/package itself into a cushioned receptacle and secure the parcel. This model can also start with the platform opened when the delivery drone arrives to directly drop the parcel into the opened cushioned receptacle from a safe height, and then secure the parcel. After each different mode of receiving is complete, the DLP will notify the user of the DPL that the parcel has been received and secured. Each DLP may have multiple users and be programmed to notify the correct user for each parcel.

In accordance with still another aspect of the invention a DLP includes a security code/device. The security code/device may be a wireless remote, and keypad or biometric panel on the DLP, or a smart phone app. After parcels are delivered, the user is notified and may access the parcel with the security code/device to safely open the DLP. The DLP may be accessed by opening the top, or by opening a door on a side, front, or rear of the DLP.

In accordance with another aspect of the invention a DLP has an opening top platform receiving a parcel/package above an interior platform. The top platform opens horizontally to allow parcels to drop onto the interior platform. The interior platform may rise to receive the parcel, or may be cushioned and the parcels may be dropped onto the interior platform. One or two parcel pushers on opposite sides of the top platform may be stationary forcing the parcel to drop into the DLP when the top platform opens, or moveably to push the parcels into an opening after the top platform is opened. The top platform may be opened when the delivery drone arrives to directly drop the parcels into the DPL onto the interior platform from a safe height. After the parcels are received, the top platform closes and the DLP notifies the user that the parcels have been received and secured. The user may then access the parcels with the security code/device to safely open the DPL.

In accordance with another aspect of the invention, there is provided a DLP which will accept in-person deliveries.

In accordance with still another aspect of the invention, there is provided a DLP method for operating a parcel delivery Drone Landing Pad (DLP), the method comprising: the drone receiving DLP location; the drone transiting to the DLP location; the drone releasing a parcel onto the DLP; the DLP receiving the parcel through an open top platform; and closing the top platform. The method may further include: the DLP receiving GPS location data and transmitting the GPS location data to the drone; programming the DLP for multiple users, notifying the users that a parcel has been delivered, and the users operating a security device to open a door into the DLP to retrieve the parcel; and either opening a split top platform to receive the parcels, or rolling the top platform onto a drum to open the top platform to receive the parcels.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a side view of a Drone Landing Pad (DLP) according to the invention.

FIG. 2 is a cross-sectional view of the DLP according to the invention.

FIG. 3 is a top view of the DLP according to the invention.

FIG. 4 is a bottom view of the DLP according to the invention.

FIG. 5 is a side view of the interior of a second DLP according to the present invention.

FIG. 6 is a top view of the second DLP according to the present invention.

FIG. 7 is a side view of the interior of a third DLP with a top platform closed, according to the present invention.

FIG. 8 is a side view of the interior of the third DLP with a split top platform open, according to the present invention.

FIG. 9 shows a side view of the interior of the third DLP with a split top platform closed, according to the present invention.

FIG. 10 and a side view of the interior of the third DLP with the split top platform 30a open, according to the present invention.

FIG. 11 shows a DLP including a door and security device, according to the present invention.

FIG. 12 shows a DLP opened to retrieve a parcel, according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

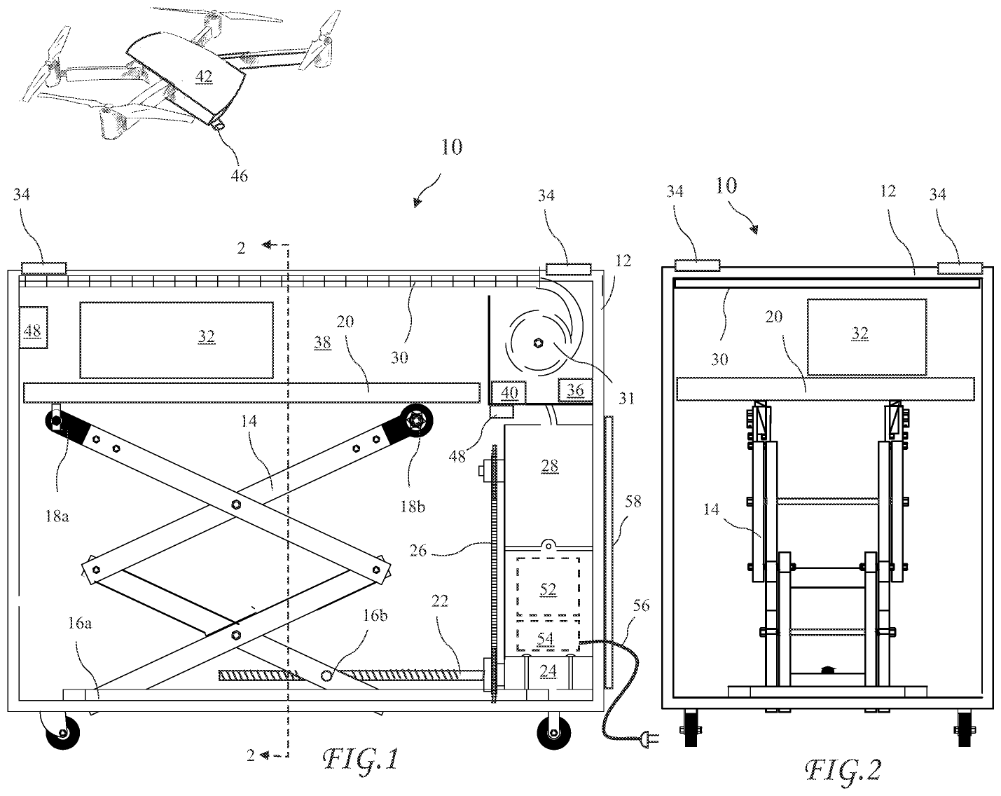

FIG. 1 shows a side view of a Drone Landing Pad (DPL) 10 according to the present invention and FIG. 2 shows a cross-sectional view of the DLP 10 taken along line 2-2 of FIG. 1. The DLP 10 provides a safe landing pad for a drone 42 for delivery of parcels 32 or other cargo and preferably includes a rectangular housing/frame 12, for example, three feet wide, five feet long, and four feet high, but the dimensions of different versions may depend on the size of the drone 42 and/or size of parcels 32, which may vary pending business and/or residential types and needs.

The DPL 10 includes a lifting/lowering device 14, lifting and lowering an internal platform 20. The lifting/lowering device 14 may be a scissors device, gear driven, a hydraulic or pneumatic type device, or any other suitable device. The scissors device 14 includes a pivoting end 16a and a translating and pivoting end 16b proximal to a base of the DLP 10, and a second pivoting end 18a and a second translating and pivoting end 18b both supporting the interior platform 20. The pivoting end 18b may be a wheel, for example a polyurethane wheel with bearings, that rolls or glides under the interior platform 20, while maintaining contact and supporting the weight of the interior platform 20 and parcels 32. The translating and pivoting end 16b may be attached to a motor 24 by a rod 22, for example, a threaded rod.

A security door or top platform 30 at the top of the DLP 10 is opened to receive parcels 32 and closed to secure the parcels 32. An example of a top platform is a roll-up top platform wound by a top platform actuator 28 onto a drum 31. The top platform actuator 28 may have a separate motor, or be connected to the motor 24 by a chain or belt 26.

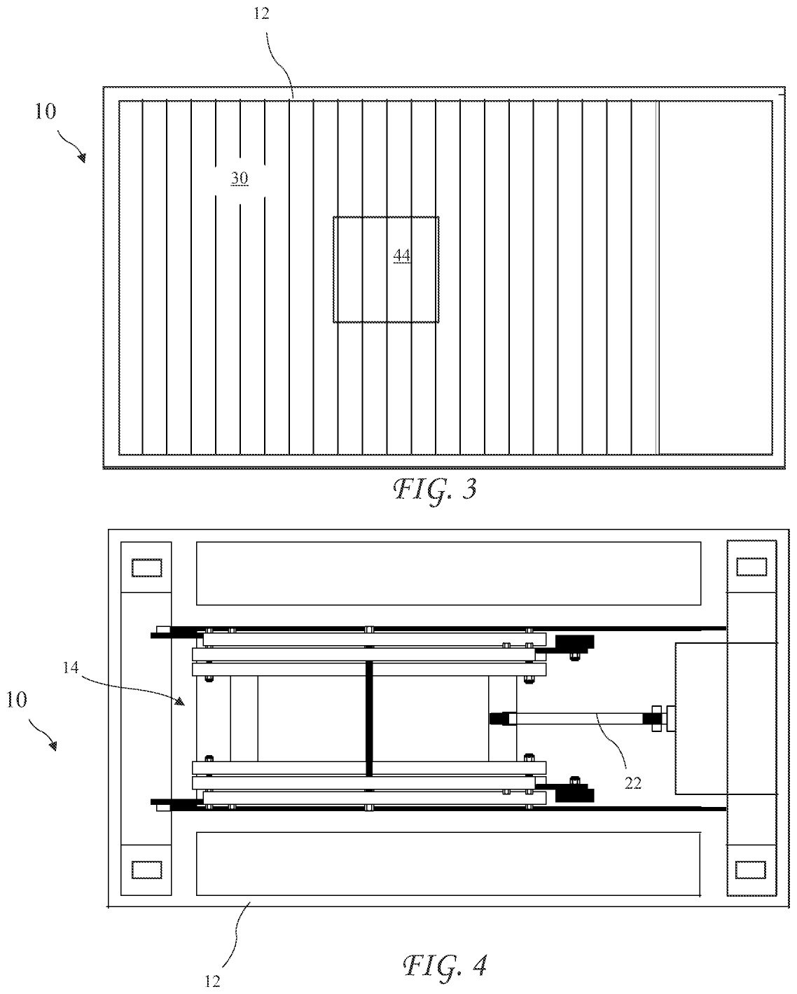

The DLP 10 may include a DLP processor/transmitter 40 which provides a DLP location to a drone 42. The DLP position may be programmed into the DLP processor 40 or a GPS sensor 36 which may be attached to the DLP 10 to provide the DLP position, for example, for a mobile or movable DLP 10. An offset between the GPS sensor 36 and a vector to the center of the interior platform 20 or top platform 30 may be programed into the DLP processor to provide a position to the drone 41. For m ore accurate connection between the DLP 10 and the drone 42, the DLP 42 may include an optical landing aid 44, for example a scan code, (see FIG. 3) applied to a top surface of the interior platform 20 and/or the top platform 30 for recognition an optical recognition camera 46 of the drone 42.

The DLP 10 may include lighting 34 built into the frame or body 12 to provide illumination during use. The lighting 34 will be positioned around the periphery of the DLP 10 to alert anyone of its impending use due to drone in vicinity prior to drop-off of a parcel delivery.

The DLP 10 may be configured for receiving and holding a single parcel 32 or may be configured to receive and hold multiple parcels 32. A sensor 48 may be configured to sense the available space in the parcel space 38 for containing additional parcels 32. The DLP processor 40 may receive the available space and transmit the available space to the drone 42 allowing the drone 42 to determine if there is room for an additional parcel 32. When the drone 42 arrives, the drone 42 locates the interior platform 20 through recognition of the optical aid 44 and positions the drone 42 centered over the interior platform 20 to land and sets the parcel 32 atop the interior platform 20. Once a parcel 32 is disengaged from drone 42, the drone 42 flies away, leaving parcel 32 on the interior platform 20. The DLP 10 recognizes the parcel 32 using sensor 48 and signals the interior platform 20 to lower. Once the interior platform 20 lowered, the top platform 30 is closed to secure the receptacle space 38 to secure parcels 32 from theft. Weather proofing designs protect the parcel 32 from the external elements. The DLP 10 preferably transmits a delivery signal to a user after the delivery.

A battery 52 and charging circuit 54 may reside in the DLP 10, and power may be provided by wiring 56 connecting to an external power source, and/or a solar panel 58 attached to the DLP 10. The battery may be, for example, a 9-volt battery or lithium battery.

A top view of the DLP 10 and a parcel 32 resting on the top platform 30 is shown in FIG. 3 and a bottom view of the DLP 10 is shown in FIG. 4.

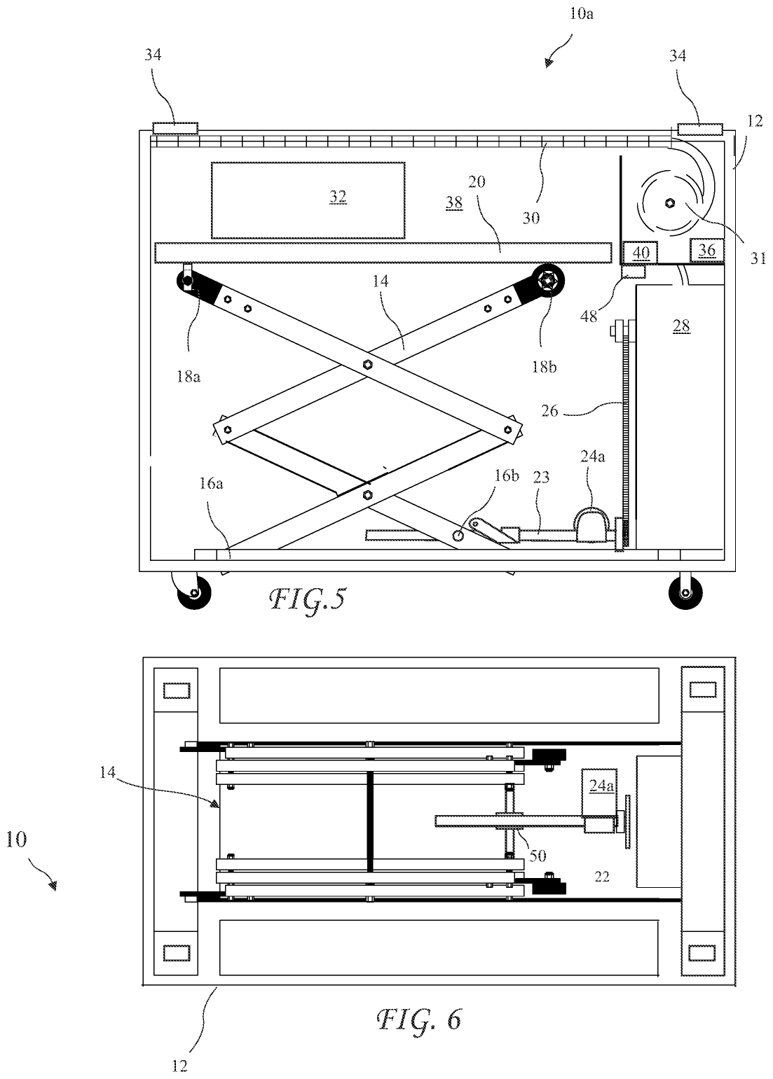

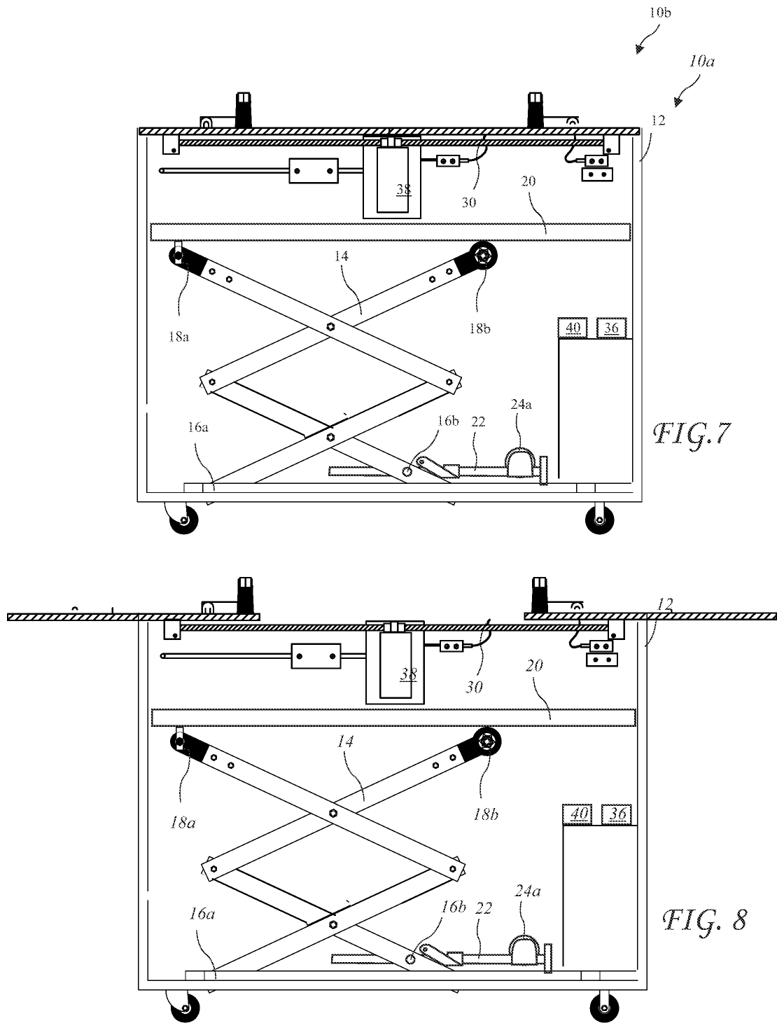

A cross-sectional view of a second DLP 10a is shown in FIG. 5 and a top view of the DLP 10a is shown in FIG. 6. The DLP 10a includes a linear actuator including a second motor 24a, track 23, and trolley 50 moved along the track by the motor 24a. The translating and pivoting end 16b is attached to the trolley 50 to raise and lower the interior platform 20. The DLP 10a may include any of the other elements of the DLP 10.

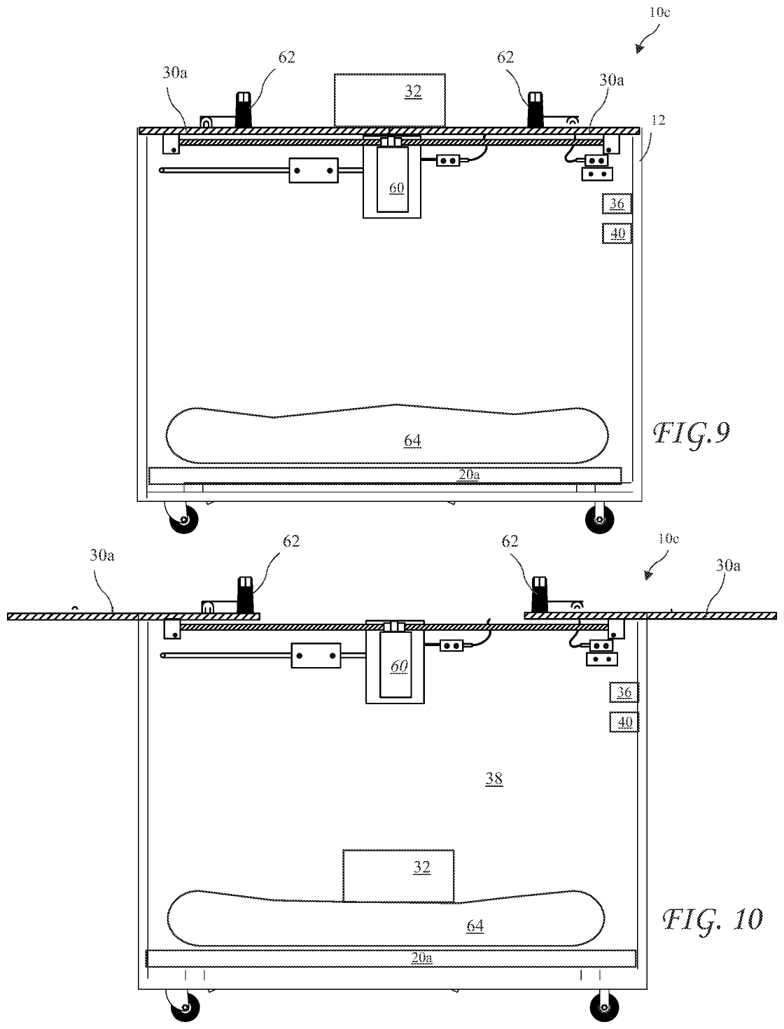

A side view of the interior of a third DLP 10c with a split top platform 30a closed is shown in FIG. 9 and a side view of the interior of the third DLP 10b with the split top platform 30a open, is shown in FIG. 10. The parcels 32 may be deposited or dropped by the drone 42 onto the closed split top platform 30a, or the split top platform 30a may be opened and the parcels 32 dropped by the drone 42 directly onto a padded interior platform 20a. When the parcels 32 are deposited or dropped by the drone 42 onto the closed split top platform 30a between parcel pushers 62, the split top platform 30a may be opened and parcel pushers 62 urge the parcels 32 to fall into the receptacle space 38 onto a cushion 64. After each different mode of receiving is complete, the DLP 10c will notify the user of the DPL that the parcels 32 have been received and secured. The use then accesses the parcel with the security code/device to safely open. The DLP 10a may include any of the other elements of the DLP 10a.

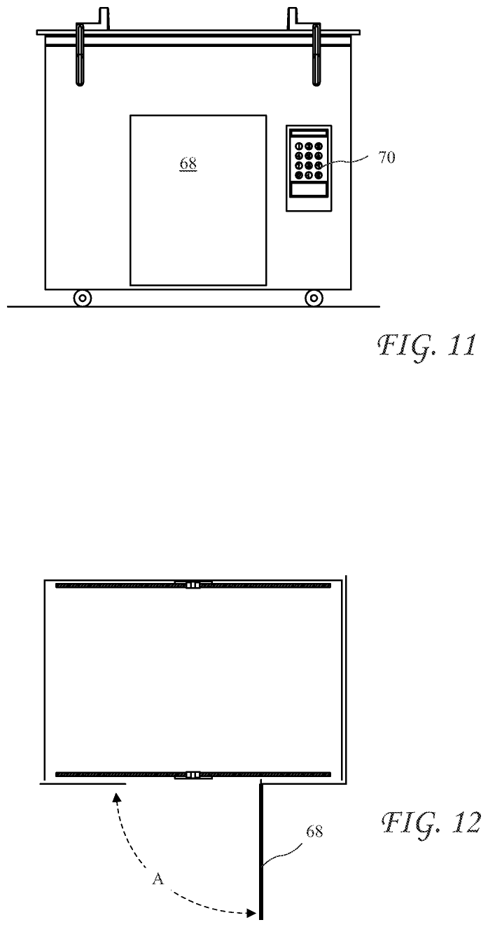

A DLP 10 including a door 68 and security device 70 is shown in FIG. 11 and the DLP opened along an arc A to retrieve a parcel 32 is shown in FIG. 12. The security device 70 may be a key pad, a key lock, a biometric device, a wireless device, and a smart phone controlled device, or any security device limiting opening to the user.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above. For example, while the above description included the use of (GPS) sensors and optical landing aids, it will be understood that other sensor emitter combinations may be used.

While the invention herein disclosed has been described by means of specific embodiments and applications thereof, numerous modifications and variations could be made thereto by those skilled in the art without departing from the scope of the invention set forth in the claims.

1. A parcel delivery Drone Landing Pad (DLP), comprising:
a housing;
a DPL interior configured to contain and secure parcels;
an interior platform residing inside the DPL interior, the interior platform including a top surface for supporting the parcels;
a top platform above the interior platform and opening to receive the parcels and closing to secure the parcels; and
a transmitter providing DLP location to the drone.

2. The DLP of claim 1, wherein the interior platform is attached to a lift.

3. The DLP of claim 2, wherein the lift is a scissors lift.

4. The DLP of claim 2, further including a sensor detecting the presence of the parcels on the interior platform and signally to lower the interior platform.

5. The DLP of claim 1, wherein:
the interior platform is stationary; and
the top surface of the interior platform is padded.

6. The DLP of claim 1, further including an electrical power source selected from the group consisting of:
solar panels and rechargeable batteries;
a back-up battery; and
a wiring to an external power source.

7. (canceled)

7. The DLP of claim 1, further including a transfer chute.

8. The DLP of claim 1, further including sensor configured to sense the available space in the DLP interior.

9. The DLP of claim 1, further including a GPS sensor unit affixed to the DLP and providing DLP location to the drone.

10. The DLP of claim 1, further including an optical landing aid detected by the drone to guide the drone to the DLP.

11. The DLP of claim 1, further including:
a sensor sensing remaining interior space in the DLP; and
a DLP receiving the remaining interior space and transmit the remaining interior space to the drone allowing the drone to determine if there is room for additional parcels.

12. The DLP of claim 1, wherein the top platform is rolled onto a drum to open the DLP interior to receive the parcel.

13. The DLP of claim 1, wherein the top platform is a split top platform separating to open the DLP interior to receive the parcel.

14. The DLP of claim 1, further including a security device and door to secure and retrieve the parcels.

15. A parcel delivery Drone Landing Pad (DLP), comprising:
a housing;
a DPL interior configured to contain and secure parcels;
an interior platform residing inside the DPL interior, the interior platform including a top surface for supporting the parcels;
a top platform above the interior platform and opening to receive the parcels and closing to secure the parcels;
a GPS device obtaining a DLP location; and
a transmitter providing the DLP location to the drone.

16. A method for operating a parcel delivery Drone Landing Pad (DLP), the method comprising:
the drone receiving DLP location;
the drone transiting to the DLP location;
the drone releasing a parcel onto the DLP;
the DLP receiving the parcel through an open top platform; and
closing the top platform.

17. The method of claim 16, further including:
the DLP receiving GPS location data; and
the DLP transmitting the GPS location data to the drone.

18. The method of claim 16, further including:
programming the DLP for multiple users;
the DLP notifying the users that a parcel has been delivered;
the users operating a security device to open a door into the DLP to retrieve the parcel.

19. The method of claim 16, further including opening a split top platform to receive the parcels.

20. The method of claim 16, further including rolling the top platform onto a drum to open the top platform to receive the parcels.
